(19) United States
(12) Patent Application Publication
(10) Pub. No.: US 2014/0091193 A1
(43) Pub. Date: Apr. 3, 2014

(54) HOLDER FOR BOOKS AND ELECTRONIC DEVICES

(71) Applicant: David Frederick Simon, (US)

(72) Inventor: David Frederick Simon, Lakeland, FL (US)

(21) Appl. No.: 13/629,941

(22) Filed: Sep. 28, 2012

(51) Int. Cl. A47B 23/04; F16B 2/06

(52) U.S. Cl. CPC A47B 23/04; F16B 2/065
USPC 248/451; 248/458; 24/569

(57) ABSTRACT

A device for holding a book or electronic viewer on a platform in which a clamping mechanism allows mounting to a supporting structure such as a piece of furniture. The clamp includes a V-shaped piece able to be fit to a corner of the furniture piece and securely engage a narrow overhang. A set of stretch cords are provided which each has tips each receivable in one of a field of holes to form loops holding corners of various sized item to the platform.

### BACKGROUND OF THE INVENTION

This invention concerns holders for books, tablet pc's, electronic book readers, etc. The present inventor has heretofore conceived and developed book holders as described in U.S. Pat. No. 7,040,591, which is incorporated herein by reference. The holder shown therein is floor mounted and has a weighted base to which is attached a vertical upright, the upright in turn holding a pivot arm assembly to which a book holder platform is attached.

It sometimes would be advantageous to support the device on furniture in particular a table instead of a base and an upright as the device would be simpler, less expensive to produce, and more compact and easily transportable.

Such tables are commonly provided next to a bed, sofa or easy chair and thus would be conveniently located for this purpose.

On the other hand, the device supports the holder platform cantilevered out from its support and the support must therefore be capable of being securely anchored to an end table or a similar furniture piece.

The introduction of tablet pc's, such as the iPad(™)and dedicated electronic readers such as the Kindle(™) book readers have brought these items into widespread use, and a device adapted to conveniently hold them would likewise be advantageous.

It is an object of the present invention to provide a compact holder device for books and electronic devices which can be supported on furniture pieces.

It is another object of the invention to provide such holder device which is adapted to hold books and also to securely hold tablet pc's and electronic reader devices of various sizes and shapes.

### SUMMARY OF THE INVENTION

The above recited objects and other objects which will be understood upon a reading of the following specification and claims are achieved by a short upright post having a clamp including clamping pieces able to grip narrow overhangs of a table top of an end table or other furniture piece.

The clamp has a 90° V-shaped clamping element comprised of two diverging flat fingers which can be fit against and to a corner to engage narrow overhang surfaces at a corner as on a furniture piece. An opposing clamp/element can be threadedly advanced against the top of the furniture piece at a location above and between the fingers of the lower clamp element.

The grip of each finger on the narrow overhang stabilizes the engagement of the other leg since each leg is positively held in its position by the presence of the clamped other leg, so that neither leg will tip or slip out of engagement with its respective narrow overhang surface.

The end result is that the upright will remain securely clamped and held on the furniture piece.

The clamp itself can also similarly mount other items to other supports.

The holder piece is mounted to the upright by an articulated swing arm assembly pivoted on the upper end of upright which is adjustable in height.

In order to hold variously sized electronic display devices on a platform on the outer end by an outer swing arm, a plurality (preferably four) fields of through holes are formed in the platform. The holes are adapted to receive ends of an elastic cord at any locations within the hole field.

The ends of the elastic cords have crimp attached metal or plastic sleeves which completely enclose the ends of each cord, but only partly enclose the cord for a portion of their length.

The sleeves are able to be inserted through any hole and then tipped on the other side of the platform to retain the cord end in any selected hole. Attaching both ends in respective holes allows a cord loop to be formed in each core at the front side of the platform.

An electronic device, book, magazine, etc. can be held to the platform by having the four corners of the item held received beneath a respective cord loop. This holder arrangement can also be used to secure other devices to other structures.

### DESCRIPTION OF THE DRAWINGS

FIG. 1 is a pictorial view of a book/electronic display holder device according to the invention supported on the corner of an end table placed next to a chain.

FIG. 2 is an enlarged pictorial view of a segment of an upright member included in the holder device shown in FIG. 1 and the clamping mechanism used to mount the same on the end table.

FIG. 3 is an enlarged pictorial view of the clamp components shown in FIG. 2 with the clamp engaging the corner of the end table shown in fragmentary form.

FIG. 4 is a pictorial view of the clamp components shown in FIG. 3 looking up from below.

FIG. 5 is a pictorial view of an alternate embodiment of the clamp components shown in FIGS. 2-5.

FIG. 6 is an enlarged pictorial view of yet another embodiment of the components shown in FIGS. 2-5.

FIG. 7 is a pictorial view of a holder device according to the invention showing an electronic display device mounted to a platform included in the device.

FIG. 8 is a pictorial rear view of a holder device showing details of the support platform having an electronic display mounted thereto shown in hidden lines.

FIG. 9 is an enlarged pictorial view of an elastic cord with one tip sleeve turned sideways to hold one end of the cord within the hole when the cord is stretched.

FIG. 10 is an enlarged pictorial view of a platform corner broken away to show the formation of a cord loop.

FIG. 11 is an enlarged pictorial view of the platform partially broken away to shown a spring loaded friction disc used to hold the platform in a selected rotated position.

FIG. 12 is an exploded pictorial view of the swing arm pivot connection components.

### DETAILED DESCRIPTION

In the following detailed description, certain specific terminology will be employed for the sake of clarity and a particular embodiment described in accordance with the requirements of 35 USC 112, but it is to be understood that the same is not intended to be limiting and should not be so construed inasmuch as the invention is capable of taking many forms and variations within the scope of the appended claims.

Referring to the Drawings, and particularly FIG. 1, a holder device 10 similar to that shown in U.S. Pat. No. 7,040,591 according to the present invention is adapted to be mounted on a furniture piece, such as the end table 14 shown adjacent a chair 16 where the user would be seated when reading a book or viewing an electronic display device (not shown in FIG. 1) mounted to a generally planar platform 18 to which the item being viewed is secured. A side table next to a bed could also be the support.

A swing arm assembly 20 connects the platform 18 to a relatively short height upright 22 which is detachably secured to the table 14 by a clamping mechanism 24.

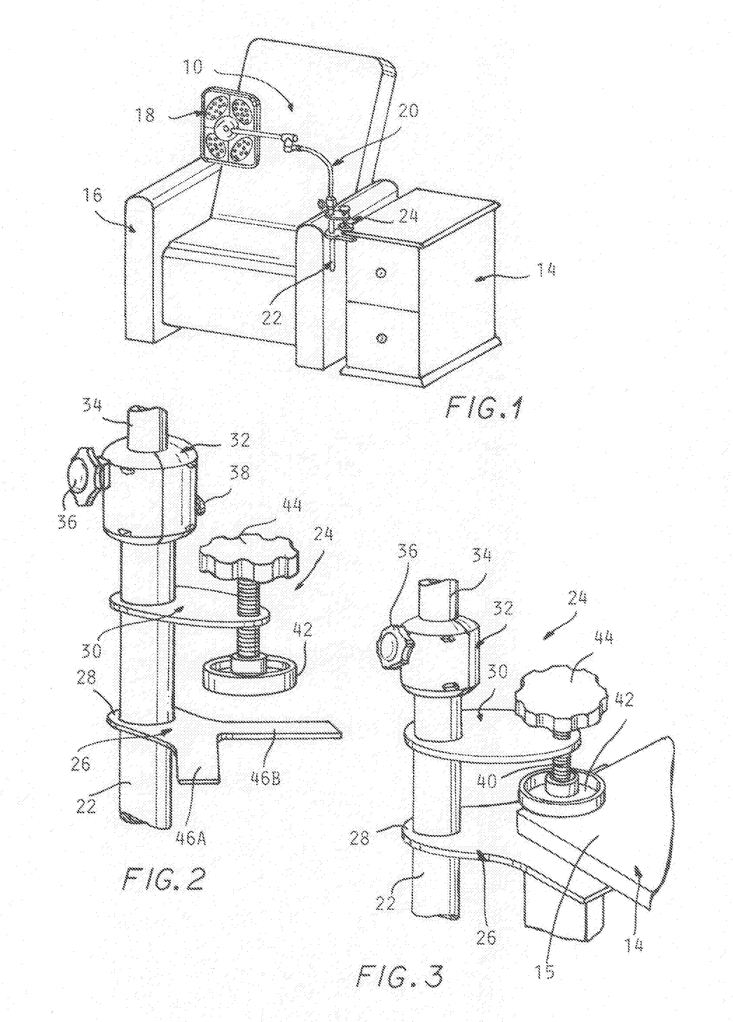

The upright 22 has a V-shaped clamp piece 26, (FIG. 2) central portion 28 welded thereto at a location below an upper clamping piece 30, both located below a split gripping collar 32 which receives a lower vertical end 70 of an inner swing arm 68 which is received into the gripper collar 32 and telescoped into the upright 22.

The two halves of collar 32 are secured together by a set of screws 31 to enclose both the lower end 70 of the inner arm 68 and the upper end of the upright 22, having portion matched to their respective diameters. Such split collar is shown and described in further detail in U.S. Pat. No. 7,040,591. An upper knob 36 tightens or loosens the grip of the gripping collar 32 on the lower vertical end 70 of the arm 68 to either secure the same in a selected telescoped position of the end 34 in the upright 22 to position the platform 18 at a desired height within the range of telescoping motion.

A lower knob 38 creates a controlled pressure on the upright 22 to vary the pressure thereon. This allows pivoting of the swing arm assembly to a desired rotated position which friction created by turning of the knob 38 will maintain.

The upper clamping piece 30 has a threaded clamping rod 40 received in a threaded hole therein to allow pressure element 42 able to be selectively brought down against or up and away from the table surface by rotation of a clamp knob 44.

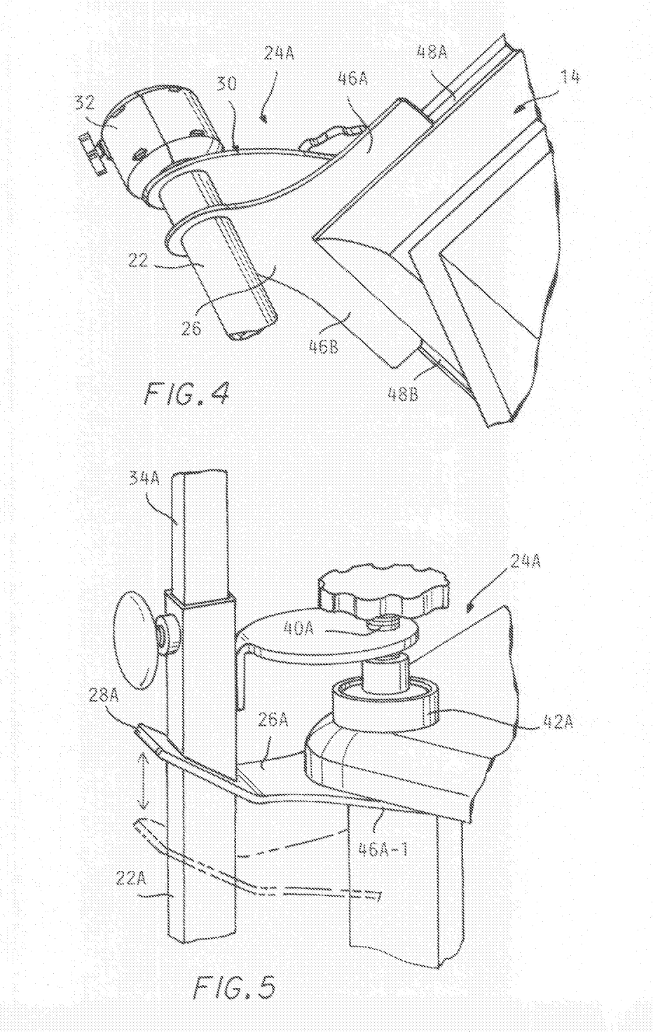

The lower clamp piece 26 has a pair of fingers 46A, 46B integral with the central piece 28 and extending at right angles to each other to form a V-shape. The fingers 46A, 46B can be aligned with the undersurface of a narrow overhangs 48A, 48B extending away from a corner of the table 14 (FIG. 4).

When the clamping element 42 is tightened against the surface of the table, the clamping piece fingers 46A, 46B are moved up to clamp against these undersurfaces.

The undersurfaces 48A, 48B may be quite narrow, such as a half inch in width, while still reliably hold the cantilevered weight of the platform and item being held. This allows a secure mound since each finger piece 46A, 46B secures the other in position since the grip is much stronger against forces applied in the lengthwise direction of the overhang undersurface. This lengthens the area engaged by each finger 46A 46B which in turn very securely resists crosswise or tipping movement of the other piece 46A, 46B as would otherwise occur by tipping or slipping off the narrow overhanging undersurfaces 48A, 48B.

Thus, a very stable securement of the clamp itself to quite narrow overhangs is achieved by the clamping mechanism 24.

The fingers 46A, 46B can also be extended beneath a straight overhang if desired, but require a deeper overhang depth in order to locate the clamping element 42 at a point lying over the surface to engage the same.

An alternate embodiment of the clamp 24A is shown in FIG. 5, in which the lower piece 26A is not straight but has an angled up central portion 28A which slidable on a square in section upright 22A rather than being welded thereto so as to be adjustably positioned thereon by lifting up on the fingers (only one finger 46A-1 visible in FIG. 5) and sliding to a desired position. The piece 26A wedges to the upright 22A when the fingers are released.

The threaded rod 40A can be shorter since it only needs limited movement to create a clamping pressure by the advance of the clamping element 42A.

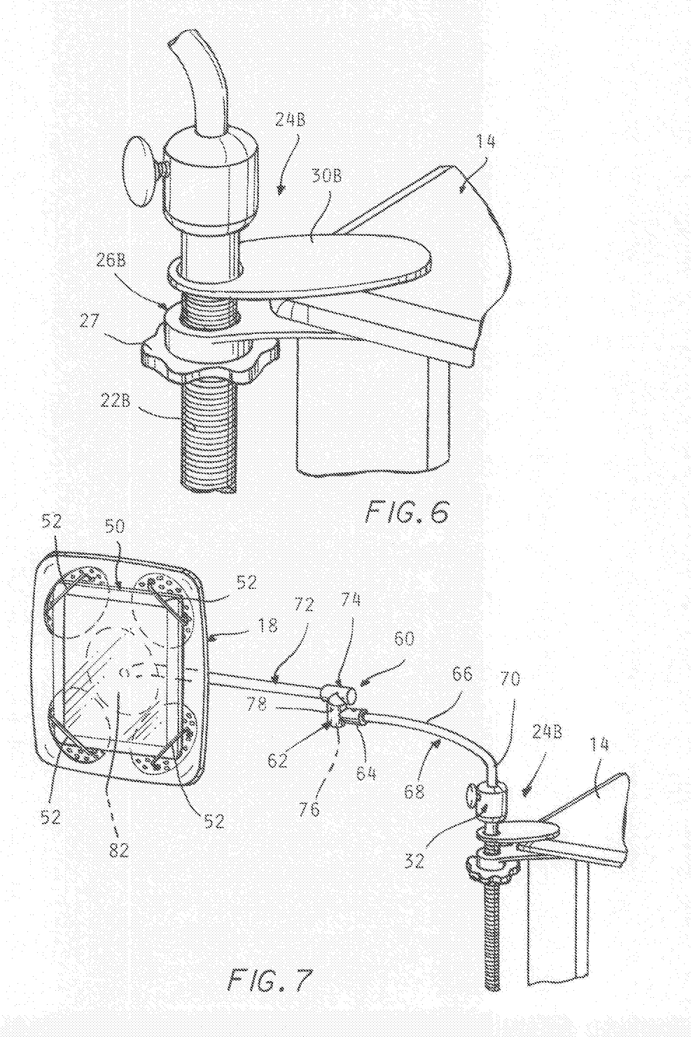

FIG. 6 shows a second alternate embodiment of the clamping mechanism 24B wherein the upright 22B is threaded and the lower piece 26B may be moved up or down by rotation of a threaded rotatable wheel 27 carried by the lower clamping piece 26B to adjust and also to clamp against the upper piece 30B which can be affixed to the upright 22B above the threaded portion thereof.

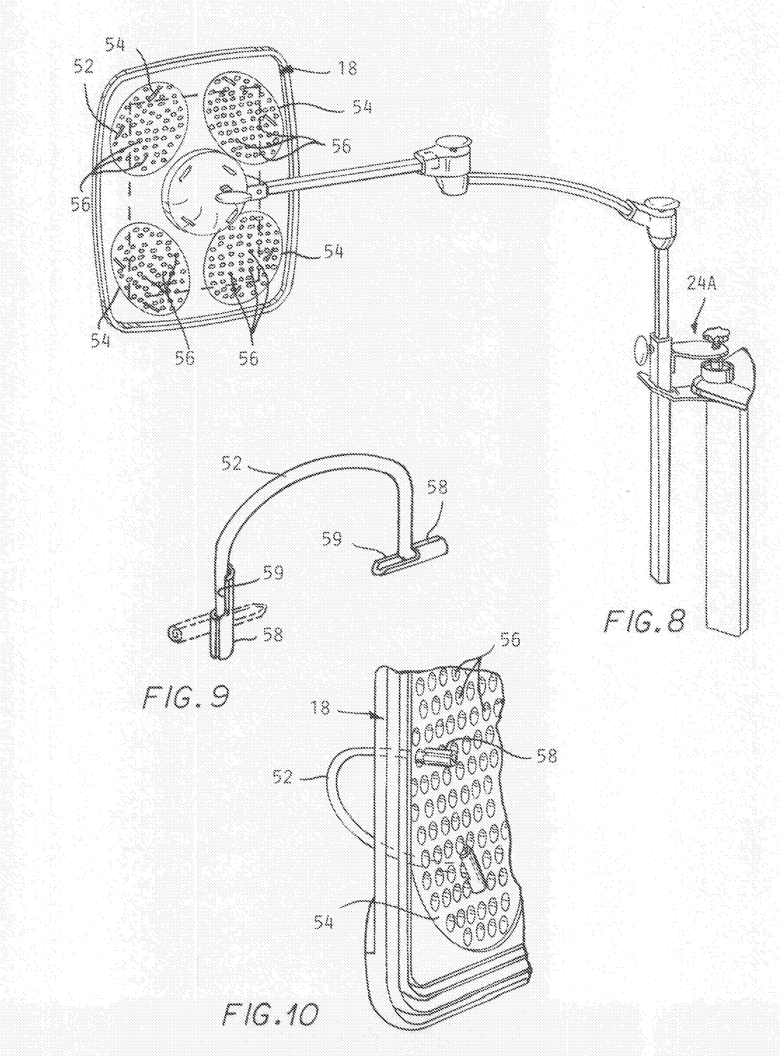

FIG. 8 shows a rectangular electronic display 50 secured to the platform 18 four by loops formed by four elastic cords 52 resiliently capturing the four corners of the display 50. The platform 18 has four oval shaped regions 54 which each have formed therein a field of through holes 56, each sized to receive tips 58 on the ends of the cords 52 crimped to each cord end 56. The tips are comprised of short length split tubes. Each tube tip 58 has a cut away segment 59 which allow tip 58 to be extended transversely by bending of the cord 52 as seen in FIG. 9A.

This allows insertion of a tip end in any hole 56, with subsequent folding over of the tip end 58 preventing pull out of the cord 52 from the hole 56 in which it is inserted.

Thus a loop can be formed by inserting the ends of a cord in respective spaced apart holes 56 as seen in FIG. 10.

The size and location of the loops 52 can be set by the selection of the particular pair of holes 56 in which the tip ends 58 are inserted.

This allows various sized and proportions of the display 50 may be securely mounted to the platform 18. The cord loops can be shortened by routing the cords 52 through two or more holes as seen in FIG. 10A.

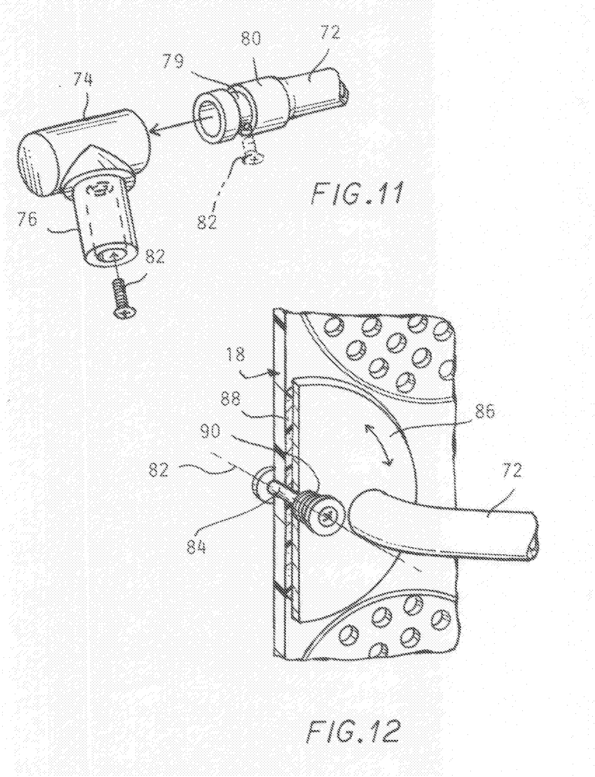

FIGS. 7 and 11 show details of the swing arm assembly in which a horizontal pivotal connection 60 is made to allow user selection of the position of the platform 18 relative the upright 22, which is described more completely in U.S. Pat. No. 7,040,591.

A first end fitting 62 has a tubular portion 64 which receives the horizontal end 66 of an inner arm 68. Swing arm 68 has a vertical segment 70 received in the split sleeve 32 to allow vertical adjustment of the platform 18.

As seen in FIG. 11, an outer swing arm 72 has an end fitting 74 attached to one end with a vertical tube 76 received in a socket 78 of end fitting 62 to create a vertical swivel axis. An enlarged end 80 of arm 72 has a slot 78 formed therein receiving the end of a screw 82 to be captured while allowing rotation of arm 72 therein.

As seen in FIG. 12, the platform 18 is pivotally adjustable about axis 82 passing through its center by being mounted on a center rod 84 with a flat disc 86 on the rod spring urged by a spring 90 to compress a friction disc 88 against the center of the rear of the platform 18. This allows rotation of the platform 18 to orient it as desired but the friction maintains the disc in any selected position, as described in U.S. Pat. No. 7,040,591.

1. An adjustable position holder device comprising:
an upright assembly including swing arm having a vertical portion telescoped into a vertical lower member also included in said upright assembly to be rotatable therein, said inner swing arm having a horizontal segment extending laterally from a vertical segment telescoped into said lower member of said upright assembly;
a clamp mechanism connected to said lower member able to be operated to engage a horizontal portion of a supporting structure, so as to secure said lower member in a vertical attitude;
a pivot fitting including a swivel element defining a vertical axis attached to a free end of said horizontal segment of said inner swing arm;
an outer swing arm having a pivot fitting affixed at one end including a swivel joint element fixed to one end mated to said swivel element of said pivot fitting of said horizontal segment of said upper member so as to orient said swing arm substantially horizontally and create a pivot connecting allowing horizontal swinging motion thereof about said vertical axis defined by said swivel element to create an articulation of said inner and outer swing arms and horizontal segment in which the outer swing arm and said horizontal segment of said inner member are able to relatively rotate to be folded together and apart by said swinging motion of said swing arms;
said pivot fitting connection also allowing rotation of said outer swing arm one end about a longitudinal axis thereof;
a generally planar platform mounted to an opposite end of said outer swing arm;
said outer swing arm of a substantial length to space said platform a substantial distance from said pivot connection to allow a substantial variation in the distance said platform lies from said vertical lower member by folding articulation of said outer swing arm and said horizontal segment of said inner swing arm; and
a frictional pivot connection between said platform and said opposite end of said swing arm allowing rotation of said platform on said swing arm only in the plane of said book support and about an axis transverse to said longitudinal axis of said outer swing arm to enable reorienting of said platform about an axis normal to and passing through the platform.

2. The device according to claim 1 wherein said clamp comprises upper and lower clamping pieces able to be relatively moved together and apart by rotation of a threaded rod engaged with one of said clamping pieces to be clamped to said horizontal support, and one of said pieces comprised of two fingers connected at one end extending at an angle to each other to form a V-shape able to be fit to a corner of said support, with said fingers straddling said corner.

3. An adjustable position holder device comprising:
an upright assembly including swing arm having a vertical portion telescoped into a vertical lower member also included in said upright assembly to be rotatable therein, said inner swing arm having a horizontal segment extending laterally from a vertical segment telescoped into said lower member of said upright assembly;
a pivot fitting including a swivel element defining a vertical axis attached to a free end of said horizontal segment of said inner swing arm;
an outer swing arm having a pivot fitting affixed at one end including a swivel joint element fixed to one end mated to said swivel element of said pivot fitting of said horizontal segment of said upper member so as to orient said swing arm substantially horizontally and create a pivot connecting allowing horizontal swinging motion thereof about said vertical axis defined by said swivel element to create an articulation of said inner and outer swing arms and horizontal segment in which the outer swing arm and said horizontal segment of said inner member are able to relatively rotate to be folded together and apart by said swinging motion of said swing arms;
said pivot fitting connection also allowing rotation of said outer swing arm one end about a longitudinal axis thereof;
a generally planar platform mounted to an opposite end of said outer swing arm;
said platform including through hole patterns formed therein each able to receive ends of a plurality of elastic cords, said elastic cord ends having tips able to be secured in said holes to be anchored therein to form loops adjustably fit to an item of varying shapes and sizes to be held on said platform;
said outer swing arm of a substantial length to space said holder a substantial distance from said pivot connection to allow a substantial variation in the distance said platform lies from said vertical lower member by folding articulation of said outer swing arm and said horizontal segment of said inner swing arm; and
a frictional pivot connection between said platform and said opposite end of said swing arm allowing rotation of said platform on said swing arm only in the plane of said book support and about an axis transverse to said longitudinal axis of said outer swing arm to enable reorienting of said platform about an axis normal to the book support.

4. A clamp comprised of two clamping pieces able to be moved together or apart by rotation of a threaded rod carrying one of said clamping pieces and threadably engaging the other piece; one of said pieces including two elongated fingers connected to each other at one end and extending apart from each other to form a angle therebetween able to be fit to straddle a corner of a structure to be received between said two fingers.

5. The clamp according to claim 4 wherein said angle between said two fingers is substantially a right angle to be fit to a right angled corner.

6. The clamp according to claim 4 wherein said other piece is located above and between said two fingers and adapted to engage a surface of said support above said corner extending out beyond said corner to create two overhang engaged by said two fingers upon tightening of said clamp.
